(19) United States
(12) Patent Application Publication
(10) Pub. No.: US 2023/0095321 A1
(43) Pub. Date: Mar. 30, 2023

(54) Solar Personal Rapid Transit System with Autonomous Pods

(71) Applicant: Solar Mobility Corp., Poughkeepsie, NY (US)

(72) Inventors: Huiming YIN, Alpine, NJ (US); Frank PAO, Boston, MA (US); Junhui LOU, Tenafly, NJ (US); Mehdi ZADSHIR, New York, NY (US)

(21) Appl. No.: 17/935,151

(22) Filed: Sep. 26, 2022

Related U.S. Application Data
(60) Provisional application No. 63/248,502, filed on Sep. 26, 2021.

(51) Int. Cl. B61B 3/02; E01B 7/04; B61C 3/00; H02S 20/21; H02S 20/23

(52) U.S. Cl. CPC B61B 3/02; E01B 7/04; B61C 3/00; H02S 20/21; H02S 20/23

(57) ABSTRACT

The solar personal rapid transit (PRT) system is configured to provide a transportation system with higher material, energy, environmental, and economic sustainability. The solar PRT system includes autonomous vehicles or “pods” that travel on a rail guideway above the pods. The pods are configured for moving people and objects from one location to another along the rail guideway. Each pod is coupled to a drive unit via a hanger for moving the pods through the guideway. The drive unit includes wheels with flanges proximate to the outside edges of the guideway rails. A combination of tongue tracks and a switch blade is used to route the pods onto different tracks. A pre-tension frame supports each section of the guideway and includes a smart cushion that changes the length of the section based on environmental temperature. The smart cushion is further used with a BIPV module for a roof.

### BACKGROUND OF THE INVENTION

Transportation accounts for 71% of the petroleum products consumed in the United States today, and this number has been increasing in the past decade. Unfortunately, the oil stock in the world is inherently finite and will be exhausted in about 40 years if we continue the current practice, which leads to a serious energy crisis in the near future. Moreover. 29% of greenhouse gas emissions are from vehicles, which contribute to global warming and climate change. As a result, parts of the transportation system may be subjected to an accelerated aging and weathering environment. The current transportation system is inadequate in material, energy, environmental, and economic sustainability and fails to adequately reduce gas consumption.

### BRIEF SUMMARY OF THE INVENTION

Disclosed herein is a solar personal rapid transit system with autonomous pods as specified in the independent claims. Embodiments of the present invention are given in the dependent claims. Embodiments of the present invention can be freely combined with each other if they are not mutually exclusive.

According to one embodiment of the present invention, a transit system includes a rail guideway with one or more junctures. Each juncture includes main tracks with a first main rail and a second main rail, turn tracks with a first turn rail and a second turn rail, a first tongue rail with a first end aligned with the first main rail and a moveable second end, and a second tongue rail with a first end aligned with the second turn rail and a moveable second end. A drive unit, with an autonomous vehicle coupled to the drive unit, travels within the rail guideway, and includes a first set of wheels for traveling on the first main rail. Each of the first set of wheels has a first flange residing proximate to an outside edge of the first main rail and distal from an inside edge of the first, main rail. The drive unit further includes a second set of wheels for traveling on the second main rail, Each of the second set of wheels has a second flange residing proximate to an outside edge of the second main rail and distal from an inside edge of the second main rail. A switch control system includes a switch blade with a pivot end and a movable end. The pivot end resides at a location proximate to the second main rail and the first turn rail, where a gap exists between the pivot end, the second main rail, and the first turn rail. The switch control system facilitates a movement of the drive unit from the main tracks to the turn tracks by positioning the moveable end of the first tongue rail to form a gap between the movable end of the first tongue rail and the first main rail, positioning the movable end of the switch blade to align with the first main rail, and positioning the moveable end of the second tongue rail to align with the second main rail.

To facilitate a movement of the drive unit and to continue its motion on the main tracks, the switch control system positions the moveable end of the first tongue rail to align with the first main rail, positions the moveable end of the switch blade to align with the second main rail and positions the movable end of the second tongue rail to form a gap between the moveable end of the second tongue rail and the second main rail.

In one aspect of the invention, the rail guideway includes an enclosure, where the main tracks, the turn tracks, the first tongue rail, and the second tongue rail reside within the enclosure. The drive unit travels within the enclosure.

In another aspect of the invention, the drive unit is part of an autonomous vehicle configured to carry persons or objects. The autonomous vehicle is coupled to the drive unit using a hanger, where the autonomous vehicle is positioned below the rail guideway.

In another aspect of the invention, the rail guideway has an opening at a bottom of the enclosure and along a length of the enclosure. The drive unit travels within the enclosure, and the hanger travels through the opening.

In another aspect of the invention, the turn tracks are positioned at a higher latitude than the main tracks to facilitate the acceleration or deceleration of the autonomous vehicle as it enters or leaves the turn tracks.

In another aspect of the invention, the rail, guideway includes' one or more circular tracks for facilitating U-turns for the drive unit.

In another aspect of the invention, the transit system includes one or more solar personal rapid transit (PRT) structures. The roof of the solar PRT structure has one or more solar panels for generating power for the transit system.

In another aspect of the invention, the rail, guideway includes one or more pre-tension frames, each frame supporting a section of the guideway. Each pre-tension frame includes a central beam coupled to the section of the rail guideway, a first girder coupled to a first end of the frame and to the central beam, a second girder coupled to a second end of the frame, and a smart cushion coupled between the central beam and the second girder. The smart cushion adjusts a length of the section of the guideway based on changes in environmental temperature.

In another aspect of the invention, the smart cushion includes a first horizontal hinge point coupled to the second girder of the frame and a second horizontal hinge point coupled to a first girder of the adjacent frame. The first horizontal hinge point is positioned at an initial distance from the second horizontal hinge point. A first vertical hinge point and a second vertical hinge point are coupled to the first horizontal hinge point and the second horizontal hinge point at approximately equal angles. The smart cushion further includes a first pair of electrodes positioned on an inside distance between the first vertical hinge point and the second vertical hinge point, and a second pair of electrodes positioned on an outside distance between the first vertical hinge point and the second vertical hinge point. A plurality of links connects the first and second horizontal hinge points and the first and second vertical hinge points. A motor is coupled to the first pair of electrodes and the second pair of electrodes. When the first pair of electrodes touch the first and second vertical hinge points, a first current flows from the first pair of electrodes to, the motor. The compressive force on the central beam is increased, a distance between the first and second girders of the frame is increased, a distance between the second girder of the frame and the first girder of the adjacent frame is decreased; and a distance between the first and second horizontal hinge points is decreased. When the second pair of electrodes touch the first and second vertical hinge points, a second current flows from the motor to the second pair of electrodes. The compressive force on the central beam is decreased, the distance between the first and second girders of the frame is decreased, the distance between the second girder of the frame and the first girder of the adjacent frame is increased, and the distance between the first and second horizontal hinge points is increased.

In another aspect of the invention, when the first and second horizontal hinge points recover the initial distance between them, the first or second pair of electrodes disengage from the first and second vertical hinge points and turn off the motor.

In another aspect of the invention, the smart cushion is used in a building integrated photovoltaic (BIPV) module. The module includes laminated glass with a first end and a second end, a first clamp, a second clamp, a central column, and the smart cushion. The first clamp includes a first end, a second end, and a first mid-point. The length of the first clamp is coupled to the first end of the BIPV module. The second clamp includes a first end, a second end, and a second mid-point. The length of the second clamp is coupled to the second end of the BIPV module. The central column includes a first end and a second end. The first end of the central column is coupled to the first mid-point of the first clamp, and the second end of the central column is coupled to the second mid-point of the second clamp. The central column is coupled beneath the BIPV module. The smart cushion is coupled between the central column and the second clamp. The smart cushion adjusts a distance between the first clamp and the second clamp based on changes in environmental temperature.

In another aspect of the invention, the smart cushion includes a first horizontal hinge point coupled to the second clamp of the BIPV module section and a second horizontal hinge point coupled to the first clamp of the adjacent BIPV module section. The first horizontal hinge point is positioned at an initial distance from the second horizontal hinge point. A first vertical hinge point and a second vertical hinge point are coupled to the first horizontal hinge point and the second horizontal hinge point at approximately equal angles. The smart cushion further includes a first pair of electrodes positioned on an inside distance between the first vertical hinge point and the second vertical hinge point, and a second pair of electrodes positioned on an outside, distance between the first vertical hinge point and the second vertical hinge point. A plurality of links connects the first and second horizontal hinge points and the first and second vertical hinge points. A motor is coupled to the first pair of electrodes and the second pair of electrodes. When the first pair of electrodes touch the first and second vertical hinge points, a first current, flows from the first pair of electrodes to the motor. The compressive force on the central column is increased, a distance between the first and second clamps of the BIPV module section is increased, a distance between the second clamp of the BIPV module section and the first clamp of the adjacent BIPV module section is decreased, and a distance between the first and second horizontal hinge points is decreased. When the second pair of electrodes touch the first and second vertical hinge points, a second current flows from the motor to, the second pair of electrodes. The compressive force on the central column is decreased, the distance between the first and second clamps of the BIPV module section is decreased, the distance between the second clamp of the BIPV module section and the first clamp of the adjacent BIPV module section is increased, and the distance between the first and second horizontal hinge points is increased.

### BRIEF DESCRIPTION OF DRAWINGS

FIG. 1 illustrates an autonomous vehicle or pod with a drive unit.

FIG. 2 illustrates a cross-sectional view of the guideway with an end view of the drive unit.

FIG. 3 illustrates conventional wheels traveling along conventional rails.

FIGS. 4A and 4B illustrate conventional railway track switching.

FIGS. 5A and 5B illustrate a switch control system for the guideway according to some embodiments.

FIG. 6 illustrates a solar PRT station.

FIG. 7 illustrates a circular guideway.

FIG. 8 illustrates a solar PRT structure.

FIG. 9 illustrates a foundation of the solar PRT structure using energy piles.

FIG. 10 illustrates a pre-tension frame.

FIGS. 11A and 11B illustrate a smart cushion.

FIG. 12 illustrates a BIPV module with clamps and a center column.

FIG. 13 illustrates the BIPV module with a smart cushion coupled to the clamps.

FIGS. 14A and 14B illustrate the stress analysis and deflection for the BIPV module.

### DETAILED DESCRIPTION OF THE INVENTION

The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

Reference in this specification to “one embodiment,” “an embodiment,” “an exemplary embodiment.” “some embodiments,” or “a preferred embodiment” means that a particular feature, structure, or characteristic described in connection with the embodiment is included in at least one embodiment of the invention. The appearances of the phrase “in one embodiment” in various places in the specification are not necessarily all referring to the same embodiment nor are separate or alternative embodiments mutually exclusive of other embodiments. Moreover, various features are described which may be exhibited by some embodiments and not by others. Similarly, various requirements are described which may be requirements for some embodiments but not other embodiments. In general, features described in one embodiment might be suitable for use in other embodiments as would be apparent to those skilled in the art.

Embodiments of the solar personal rapid transit (PRT) system are configured to provide a transportation system with higher material, energy, environmental, and economic sustainability. The Solar PRT system includes autonomous vehicles or “pods” that travel on a rail guideway above the pods. The pods are configured for moving people and objects from one location to another along the rail guideway. Each pod is coupled to a drive unit via a hanger for moving the pods through the guideway. The drive unit includes wheels with flanges proximate to the outside edges of the guideway rails. A combination of tongue tracks and a switch blade is used to route the pods onto different tracks.

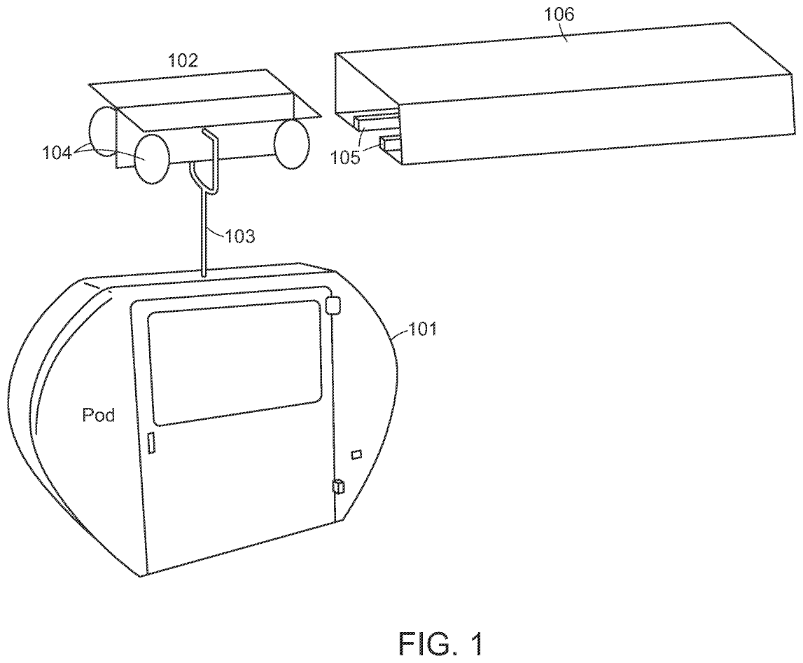

FIG. 1 illustrates an autonomous vehicle or pod with a drive unit. In some embodiments, the pod 101 is composed of fiber-reinforced ultra-light material (e.g., <1000 lbs for a 5-person pod) with good thermal and acoustic insulation. In some embodiments, the pod 101 is composed of a high-energy absorptive lightweight foam material. The materials are chosen based on their ability to enhance the safety of the pod's occupants should the pod 101 becomes disengaged from the drive unit 102 and falls. The pod 101 is driven by a drive unit 102 located above the pod 101. The pod 101 attaches to the drive unit 102 through a hanger 103. The drive unit 102 moves along the rails 105 in the guideway 106. The drive unit 102 includes a set of wheels 104 and a microprocessor (not shown). The microprocessor controls the drive unit 102 through a bogie connected to a driving wheel. The drive unit 102 communicates with a server (not shown), which directs and coordinates the movements of a plurality of pods 101. The server communicates with each of the pods 101 to obtain their respective locations and destinations, senses their respective surrounding environments for emergency responses, and manages their respective power levels for mileage-to-charge and inner environments (e.g., temperature and CO₂ levels). A battery and a wireless charger (not shown) are embedded in the drive unit 102 of each pod 101. When a pod 101 is stopped at a station, the battery of the pod 101 is automatically charged. When the energy level in the battery of a pod 101 is low, the drive unit 102 can communicate with the stations and request a battery replacement.

The lightweight material of the pods 101 allows the use of smaller guideways 106 and support structures than existing mass transit systems such as conventional light rail. The pods 101 communicate with each other, a data server, and other devices, such that each pod 101 moves through the guideway network as an independent vehicle without a driver. The server dispatches any one or more of the pods 101 according to a current transit demand. Each pod 101 is configured with sensors, and the microprocessor of each pod is configured with the ability to control the pod 101, even if the pod cannot communicate with other pods or with the server.

Initially, a pod 101 sends a message to the server to indicate its availability to perform services. In response to receiving this message, the server includes the pod 101 in the dispatching system and sends a service command to the pod 101 based on an input from a passenger or a network need. The server then analyzes a “time-load-map” received from a load balancer and selects a route between a starting location and a destination in the guideway for the given pod 101 according to the load, distance, travel time, customer requests, and other parameters. The server then sends the route to the pod 101, each network device on the route (e.g., switches, reporters, etc.), and the load balancer. As the pod 101 navigates along the route, the network devices exchange messages in, order to coordinate their behaviors. Inputs received from the sensors of the network devices are used in their coordination. The acceleration and deceleration of the pod 101 can be facilitated by changing the height of the guideway 106, as described further below.

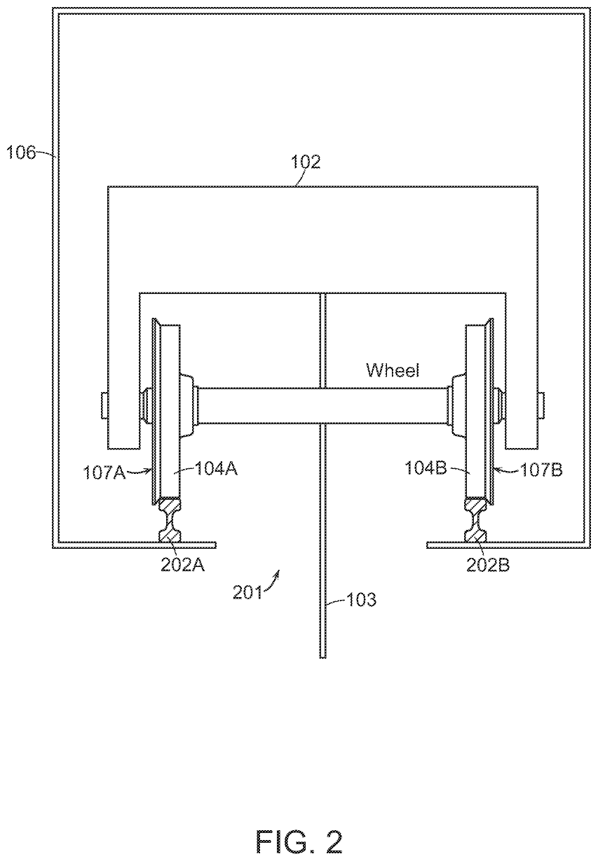

FIG. 2 illustrates a cross-sectional view of the guideway with an end view of the drive unit. The guideway 106 forms an enclosure for a set of tracks with an opening 201 at the bottom and along the length of the guideway 106. Each set of tracks includes rails 202A-202B, fasteners, and other support for the rails. The rails 202A-202B are coupled to each side of the opening 201. The hanger 103 traverses the opening 201 and couples the pod 101 to the drive unit 102. A first set of wheels 104A of the drive unit 102 engages and travels along the first rail 202A. The second set of wheels 104B of the drive unit 102 engages and travels along the second rail 202B. Although only one wheel of the first and second set of wheels 104A-104B are shown in FIG. 2, each set of wheels 104A-104B may include multiple wheels. Each wheel 104A-104B of the drive unit 102 includes a flange 107A-107B which extends beyond the diameter of the remainder of the wheel 104A-104B and resides proximate to the outside edge and distal from the inside edge of each rail 202A-202B. As the drive unit 102 moves along the rails 202A-202B, the flanges 107A-107B can engage the outside edge of the rails 202A-202B, ensuring that the wheels 104A-104B remain on the rails 202A-202B.

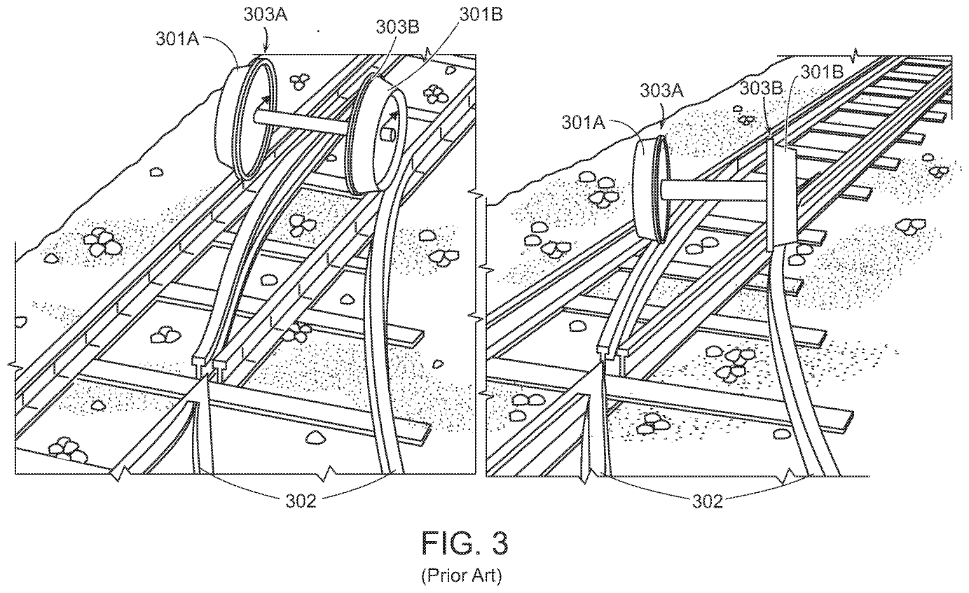

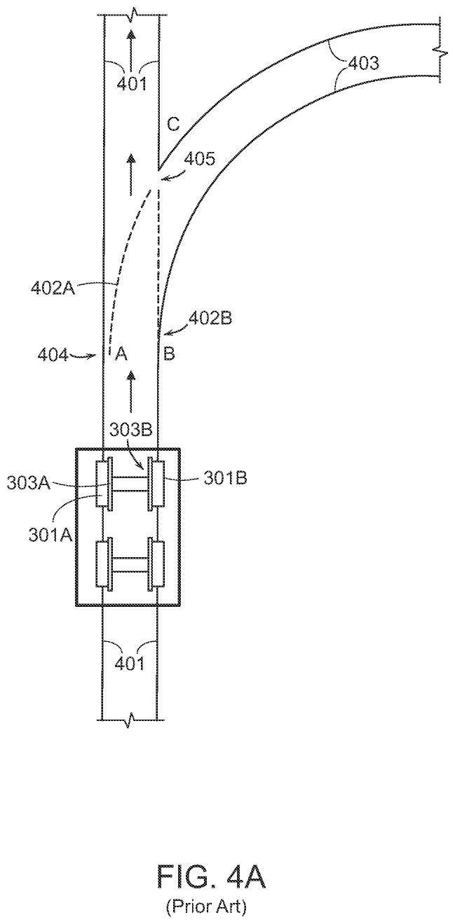

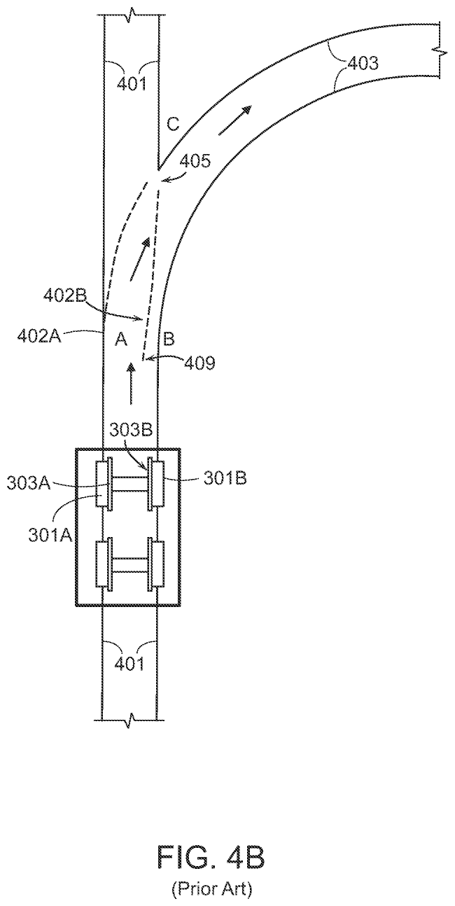

FIG. 3 illustrates conventional wheels 301A-301B traveling along conventional rails 302. The conventional wheels 301A-301B include flanges 303A-303B that are proximate to the inside edge of each rail 302. FIGS. 4A and 4B illustrate conventional railway track switching. The railway tracks include main tracks 401 and turn tracks 403, which are fixed tracks. The railway tracks also include a left tongue rail 402A and a right tongue rail 402B, which are movable rails. Each wheel 301A-301B of a conventional rail vehicle includes a flange 303A-303B that resides proximate to the inside edge of the tracks.

As illustrated in FIG. 4A, when the conventional rail vehicle is to travel on the main tracks 401 without turning, the left tongue rail 402A is moved to form a gap 404 at point A between the left tongue rail 402A and a left rail of the main tracks 401. The right tongue rail 402B is aligned with a right rail of the main tracks 401 at point B. A gap 405 exists between the left tongue rail 402A and the right tongue rail 402B at point C. As the left set of wheels 301A reaches point A, the flanges 303A of the left wheels 301A travel through the gap 404 and between the left rail of the main tracks 401 and the left tongue rail 402A. As the right set of wheels 301B reaches point B, the flanges 303B of the right set of wheels 301B travel proximate to the inside of the right rail of the main tracks 401. As the right set of wheels 301B reaches point C, the right set of wheels 301B travel through the gap 405 and continue onto the right rail of the main tracks 401.

As illustrated in FIG. 4B, when the conventional rail vehicle is to turn off the main tracks 401 and onto the turn tracks 403, the left tongue rail 402A is moved to align the left tongue rail 402A with the left rail of the main tracks 401 at point A, and the right tongue rail 402B is moved away from the right rail of the main tracks 401 at point B to form gap 409. As the left set of wheels 301A reaches point A, the flanges 303A of the left set of wheels 301A travel proximate to the inside edge of the left tongue rail 402A. At point B, the right set of wheels 301B travel through the gap 409 between the right tongue rail 402B and the right rail of the turn tracks 403. As the left set of wheels 301A approaches point C, the left set of wheels 301A travels through the gap 405 and onto, the left rail of the turn tracks 403. The right set of wheels 301B continues onto the right rail of the turn tracks 403.

However, with the guideway rails 202A-202B according to embodiments of the present invention, the flanges 107A-107B of the wheels 104A-104B of the drive unit 102 are positioned proximate to the outside edge of the rails 202A-202B (see FIG. 2), rather than the inside edge. With this positioning of the flanges 107A-107B, the conventional switching illustrated in FIGS. 4A and 4B cannot be used.

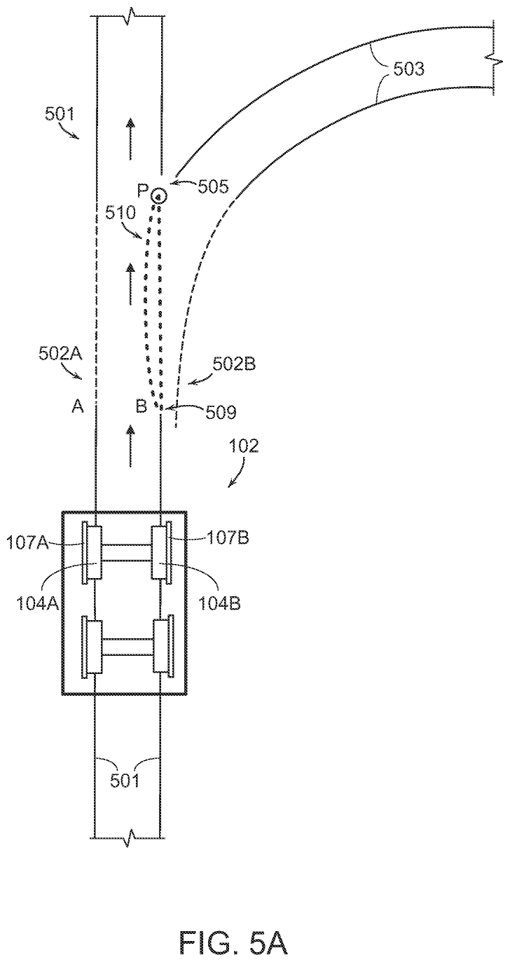

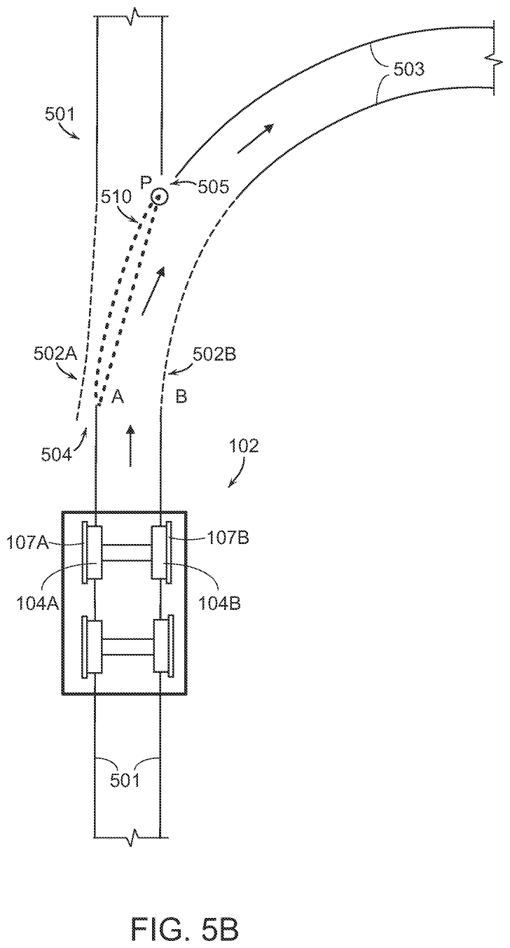

FIGS. 5A and 5B illustrate a switch control system for the guideway according to some embodiments. Switch controls are located at each juncture of the guideway to facilitate the switching of individual pods between tracks. Each juncture includes main tracks 501 and turn tracks 503, which are fixed tracks. The juncture also includes a left tongue rail 502A and a right tongue rail 502B, which are movable rails at one end. The switch control includes a switch blade 510. The main tracks 501, turn tracks 503, tongue rails 502A-502B, and the switch blade 510 reside within the enclosure of the guideway 106. The switch blade 510 is configured with a pivot at one end which rotates around point P and a movable end. An electric motor (not shown) is configured to control the operation of the tongue rails 502A-502B and switch blade 510 at their corresponding juncture.

As illustrated in FIG. 5A, when the drive unit 102 is to travel on the main tracks 501 without turning, the left tongue rail 502A is positioned to be aligned with the left rail of the main tracks 501 at point A. The movable end of the right tongue rail 502B is moved to form a gap 509 at point B between the right tongue rail 502B and a right rail of the main tracks 501. The switch blade 510 is positioned so that the moveable end of the blade aligns with the right rail of the main tracks 501 at point B. At point P, a gap 505 exists between the pivot end of the switch blade 510, the right rail of the main tracks 501, and the left, rail of the turn tracks 505. As the right set of wheels 104B of the drive unit 102 reaches point B, the right set of wheels 104B travel through the gap 509 with the flanges 107B proximate to the right side of the switch blade 510 and continue onto the switch blade 510. As the drive unit 102 reaches point P, the flanges 107B of the right set of wheels 104B travel through the gap 505 and continue on the right rail of the main tracks 501. The left set of wheels 104A travels onto the left tongue rail 502A at point A and continues on the left rail of the main tracks 501.

As illustrated in FIG. 5B, when the drive unit 102 is to turn off the main tracks 501 and onto the turn tracks 503, the moveable end of the left tongue rail 502A is positioned to form a gap 504 with the left rail of the main tracks 501 at point A. The movable end of the switch blade 510 is pivoted or rotated to align with the left rail of the main tracks 501 at point A. The right tongue rail 502B is positioned to align with the right rail of the main tracks 501 at point B. As the left set of wheels 104A of the drive unit 102 reaches point A, the flanges 107A of the left set of wheels 104A travel through the gap 504 with the flanges 107A proximate to the left edge of the switch blade 510 and continue onto the switch blade 510. As the left set of wheels 104A reaches point P, the left set of wheels 104A travels through the gap 505 and continues onto the left rail of the turn tracks 503. The right set of wheels 104B of the drive unit 102 travel from the right rail of the main tracks 501 onto the right tongue, rail 502 at point B, and then continue onto the right rail of the turn tracks 503.

Although FIGS. 5A and 5B illustrate turning the drive unit 102 to the right, the same technique is used to turn the drive unit 102 to the left.

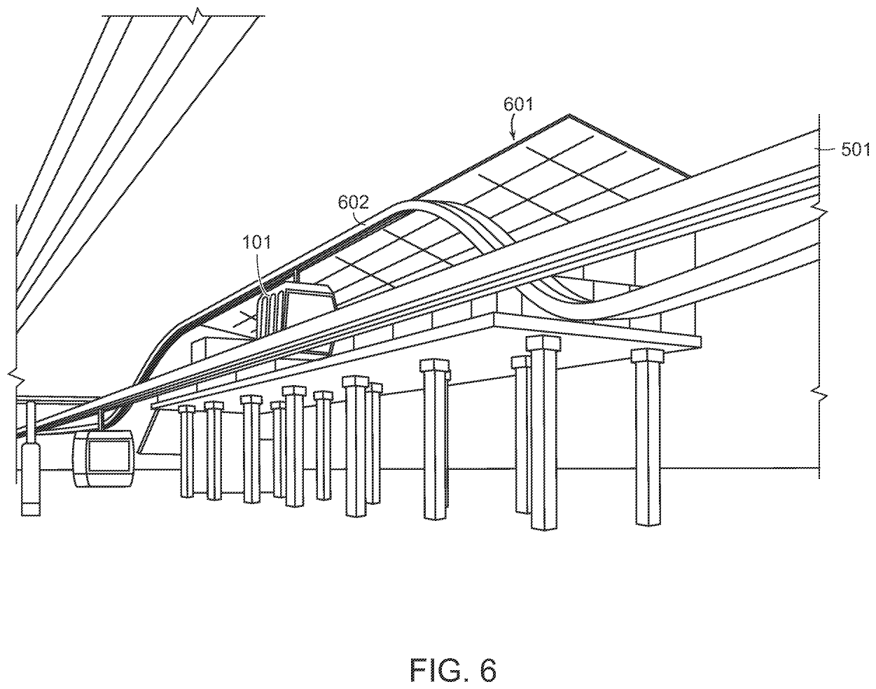

The switch control, as described above, is used to connect solar PRT stations, facilitate U-turns, and to route pods to network links or service facilities. FIG. 6 illustrates a solar PRT station 601. Individual pods 101 are routed to the solar PRT station 601 by switching the pod 101 onto branch tracks 602 for the solar PRT station 601. Pods 101 are routed to bypass the solar PRT station 601 by switching (or maintaining) the pods 101 on the main tracks 501. In some embodiments, the elevation of the branch tracks 602 is higher than the main tracks 501 to facilitate the deceleration and stopping of the pods 101 as they arrive at the solar PRT station 601, and to facilitate the acceleration of the pods 101 as they leave the solar PRT station 601 and merges with other pods traveling on the main tracks 501. Although FIG. 6 illustrates a one-way solar PRT station, a two-way solar PRT station may also be configured using similar techniques.

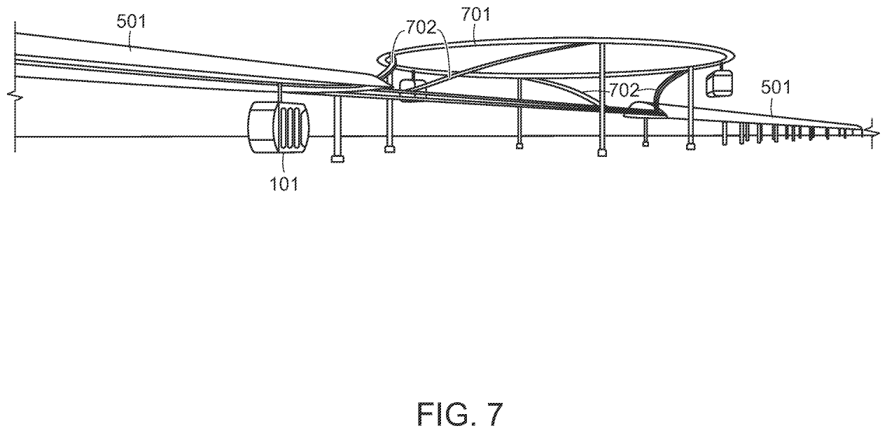

To facilitate U-turns or bypasses, a circular guideway may be used. FIG. 7 illustrates a circular guideway. A pod 101 traveling on main tracks 501 may be routed onto the circular guideway 701 via ramp guideways 702 using the switch control described above, and routed back onto the main tracks 501 such that the pod 101 is traveling in the opposite direction. A pod 101 may continue on the main tracks 501 and bypass the circular guideway 701 if no U-turn is to be performed. In this embodiment, the circular guideway 701 is elevated higher than the main tracks 501 to facilitate the deceleration of the pod 101 for turning as it enters the circular guideway 701, and to facilitate the acceleration of the pod 101 as it leaves the circular guideway 701 and merges with other pods on the main tracks 501.

When a sharp turn is needed, the guideway's elevation or latitude may also be increased to facilitate the deceleration of the pod 101 as it enters the turn and to facilitate the acceleration of the pod 101 as it exits the turn. The latitude change (H) depends on the curvature radius (R), speed limit (V), and acceleration/deceleration limit (A), which can be estimated by the following equation:

H=(V²−AR)/(2 g)

where g is the gravity acceleration constant.

The structural design of the guideways depends on the relevant building code and governmental policies. The speed limit and acceleration limit are partly based on local, state, and/or national building criteria, as well as the survey and safety records of the guideway in operation. For example, the speed target may be configured at V=40 mph and A=0.1 g. As a reference, standard values of acceleration and jerk criteria are limited to 0.09-0.15 g and 0.03-0.09 g/s for existing public highway or railway transportation in many countries.

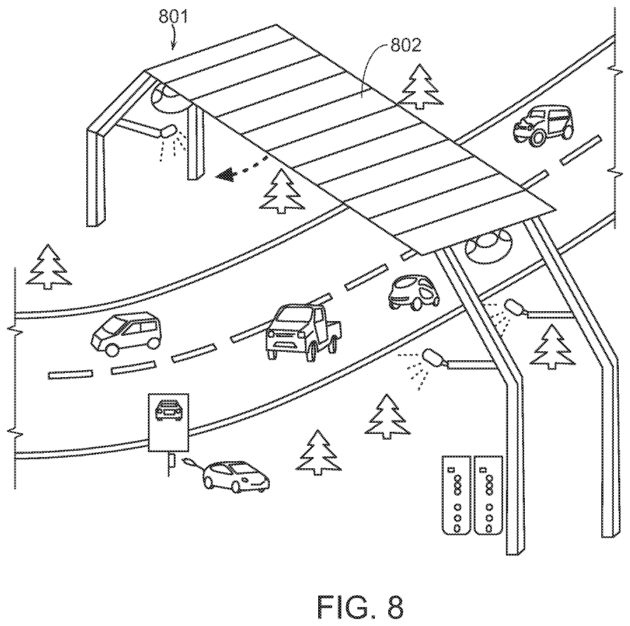

FIG. 8 illustrates a solar PRT structure. The solar PRT structure 801 integrates multiple functions in energy harvesting, dynamic aerial transit service, intelligent transportation communication and control, guideway protection, and other PRT services. The solar PRT structure 801 includes a solar roof 802 composed of solar panels to generate power for various PRT services. When the solar PRT structure 801 covers a sidewalk, power for street and community services may also be provided. The roof 802 of the solar PRT structure 801 uses building integrated photovoltaic thermal (BIPVT) technologies. The solar PRT structure 801 performs multiple functions for both solar energy harvesting and PRT services using the pods 101. In addition, the building envelope of the structure 801 protects the road and PRT infrastructure, collects water and avoids secondary pollution by surface, runoff, and hosts smart traffic monitoring and control through vehicle-infrastructure connections using sensing and information technologies. Optionally, the structure 801 may supply electricity for electric cars. This contributes to energy savings and a reduction of gas emission reduction from the transportation system and provides a clean energy platform for hybrid-electric and electric Vehicle applications. In addition, this infrastructure system enables lifetime extension, modular construction, operation cost reduction, and safety and security enhancement of the transportation system.

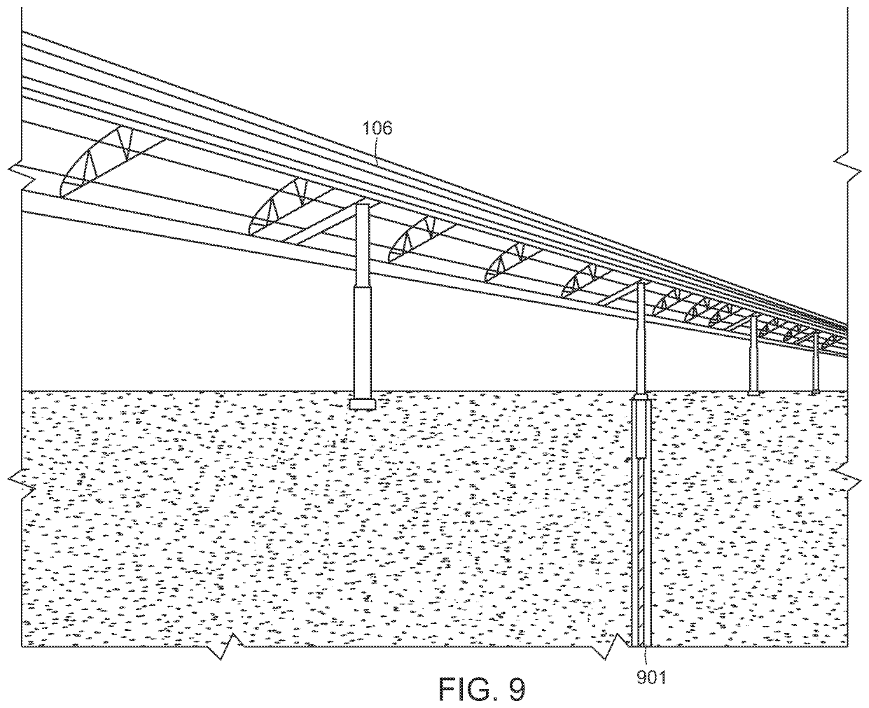

As illustrated in FIG. 9, the foundation of the solar PRT structure uses energy piles 901, installed by drilling a deep vertical borehole of 30-50 feet, depending partly on the soil profile and bearing capacity. Thermal coils made of steel pipe service both as reinforcement for the foundation and for geothermal heat exchange. During the design of the PRT structure, various loads are considered. For example, a solar panel has a weight of approximately 5 pounds per square foot (psf). The guideway 106 is approximately 40 pounds per foot. A pod with 5 passengers is approximately 2200 lbs. (1000 lbs, for the pod and 1200 lbs. for 5 passengers), with a minimum interval of 25 feet between pods. Wind, snow, rain, seismic, and other live loads will be factored in for the worst-case loading combination for each structural component. The structural performance criteria include both the stress analysis to avoid the strength failure at the extreme loading scenario and also the largest deformation of the structure when the pod 101 moves along the guideway 106. Due to the relatively long load transferring path of the rail-beam-girder-column-foundation, the sagging of the rail under the pod loading will be particularly important for riding comfort and safety. The traditional design based on the classic (Bernoulli Euler's) beam theory will be wasteful and inefficient for material usage and sagging.

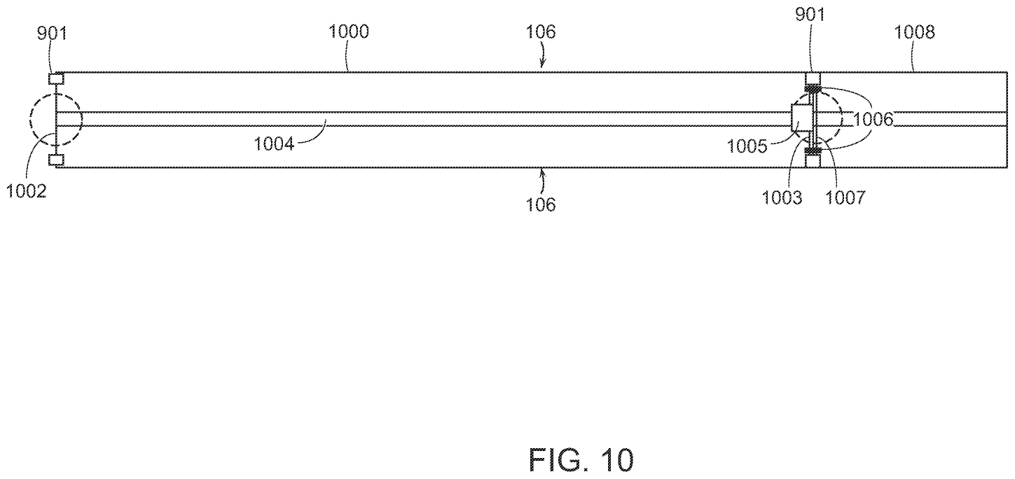

FIG. 10 illustrates a pre-tension frame. The pre-tension frame 1000 supports a section of the guideway 106 between two supporting piles 901. The frame 1000 is repetitively connected with neighboring frames throughout the guideway 106 by force sensitive connecting bolts 1006. A frame 1000 is connected to two girders 1002 and 1003, one at each end. The girders 1002, 1003 are connected to a central beam 1004 to distribute the load on the pile 901 to the ground. The first girder 1002 is fixed on the supporting pile 901, and the other girder 1003 is supported by a roller that allows for horizontal motion. Rigid connections are fabricated between the girders 1002, 1003 and frame 1000 and between the first girder 1002 and the central beam 1004 during manufacturing. A smart cushion 1005, described further below, is installed between the second girder 1003 and the central beam 1004. The central beam 1004 uses a smart cushion to provide a compressive force to the central beam 1004 and to elongate the frame 1000, as described below. The frame 1008 is adjacent to the frame 1000. The first girder 1007 of the frame 1008 is connected to one end of the frame 1008. The first girder 1007 of the frame 1008 is next to the second girder 1003 of the frame 1000.

At an initial condition, the highest working temperature Tₕ for the geographic region is determined. For example, Tₕ=50° C. for New York state. The length of the frame 1000 at Tₕ=50° C. is calculated as Lₕ. If on the date of the installation, the temperature differs, the smart cushion 1005 is used to adjust the length to Lₕ, which means when the temperature reaches Tₕ, the smart cushion 1005 exhibits, zero force.

In some embodiments, modular construction is used to install the frame 1000. The frame 1000 with length Lₕ is installed onto the piles 901 with sufficient horizontal support to stabilize the frame 1000. The connecting bolts 1006 are used to link frame 1000 and frame 1008 together. The connecting bolts 1006 are pressure sensitive. The installation pressure (or tension force in the bolt) is given at T0. The frames can be installed with substantially zero gaps between frame 1000 and frame 1008 so that the pods 101 can drive smoothly on the guideway.

When the temperature changes, the bold pressure T shifts from T0. This triggers the smart cushion 1005 to adjust the elongation of the frame 1000 such that the Pressure on the connecting, bolts 1006 can recover to T0, In this manner, the frame 1000 functions as a pre-tension mechanism. The pre-tension mechanism is applied to the modular construction of the guideway structure. The pre-tension of the rail is monitored and controlled in accordance with predetermined parameters under different seasons or ambient temperature changes such that the rail gap between frame 1000 and frame 1008 remain nearly zero. For a curved guideway, the pre-tension frame is not necessary as the gap can be adjusted by the curvature radius change.

With the pre-tension frame 1000, a minimal gap exists between support structures. This reduces the noise and enhances the ride comfort of passengers. The pre-tension in the guideway, reduces the sagging at a ratio of 50-90% depending on the length of the frame 1000 and the weight of the pods 101, which will increase the driving energy efficiency and riding comfort as well. Due to the reduced sagging, longer spans of the supporting structure may be used for different road conditions, which significantly reduces the construction difficulty and costs.

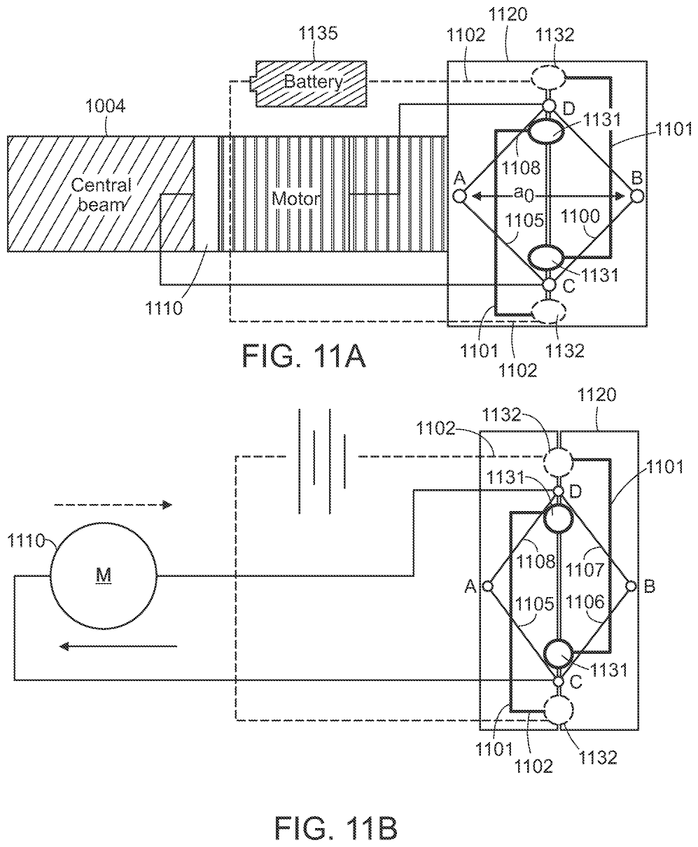

FIGS. 11A and 11B illustrate a smart cushion. FIG. 11A illustrates an embodiment of the smart, cushion 1005 coupled to the central beam 1004. FIG. 11B illustrates an embodiment of the electrical circuit to control the spacing between the second girder 1003 of frame 1000 and the first girder 1007 of frame 1008 by the smart cushion 1005. Referring to FIG. 11A, the smart cushion 1005 includes a rhombus-shaped frame 1120 with, four hinge points A-D, each of which is free to rotate around a hinge center point. A first horizontal hinge point A is fixed on the second girder 1003 of the frame 1000, and a second horizontal hinge point B is fixed on the first girder 1007 of the adjacent frame 1008. The two vertical hinge points C-D are able to move toward or away from each other as the gap between the girders 1003 and 1007 increases or decreases, respectively. The horizontal hinge point A and vertical hinge point D are fixed on the girder 1003 and the girder 1007 respectively with a distance a₀ during the installation of the frame 1000 and 1008. Links 1105-1108 are installed between the hinge points A-D and are configured at an equal angle of 90 degrees. Therefore, the distance between the points C and D is also a₀. The smart cushion 1005 includes two pairs of electrodes 1131-1132 coupled to a motor 1110 with a screw block. A first pair of electrodes 1131 is installed on the inside distance between the vertical hinge points C-D. A second pair of electrodes 1132 is installed on the outside distance between the vertical hinge points C-D. The electrodes 1131-1132 are configured along a line consistent with vertical hinge points C-D and exhibit a distance Δ (e.g., approximately 0.2 mm, based on a sensitivity requirement) between the electrodes 1131-1132 and the closest electrode at point C or D. A battery 1135 is connected to the electrodes 1131-1132. The electrodes 1131-1132 function as a switch for the motor 1110, as described below.

When the frame 1000 experiences contraction due to a temperature decrease, the distance between the girder 1003 and the girder 1007 increases from their initial distance. As a result, the distance between the horizontal hinge points A-B increases from their initial distance, and the vertical hinge points C-D move toward each other. When the vertical, hinge points C-D touch the inside electrodes 1131, the electrodes 1131 complete a first circuit 1101 and triggers the motor 1110. As illustrated in FIG. 11B, a current flows from the inside electrodes 1131 to the motor 1110, causing the motor 1110 to move the girder 1003 away from the central beam 1004, increasing the force on the central beam 1004, and increasing the distance between the girder 1003 and the girder 1002. This causes the girder 1003 to move closer to the girder 1007 so that the distance between the horizontal hinge points A-B decreases. When the horizontal hinge points A-B recover their initial distance, the vertical hinge points C-D disengage from the electrodes 1131, turning off the motor 1110.

When the frame 1000 experiences expansion due to a temperature increase, the distance between the girder 1003 and the girder 1007 decreases from their initial distance. As a result, the distance between the hinge points A-B decreases from their initial distance, and the vertical hinge points C-D move away from each other. When the vertical hinge points C-D touch the outside electrodes 1132, the electrodes 1132 complete a second circuit 1102 and triggers the motor 1110. As illustrated in FIG. 11B, a current flows from the motor 110 to the outside electrodes 1132, causing the motor 1110 to move the girder 1003 closer to the central beam 1004, decreasing the force on the central beam 1004, and decreasing the distance between the girder 1003 and the girder 1002. This causes the girder 1003 to move away from the girder 1007 so that the distance between the horizontal hinge points A-B increases. When the horizontal hinge points A-B recover their initial distance, the vertical hinge points C-D disengage from the electrodes 1132, turning off the motor 1110.

In an exemplary embodiment, the solar PRT system forms a physical “Internet” of pods. Each section or supporting structure of the guideway will be assigned a unique identifier, which is associated with one area zone managed by a server. The areas of the solar PRT system may be divided into zones, and the server may allow new zones to be added, thus providing a scalable system. For each zone, a software application executed by the server manages the pods and guideway sections in its domain. Any infrastructure problem and accident traced by the server is reported to an emergency response team for timely rescue or maintenance.

In an exemplary embodiment, an individual pod is associated with a particular zone. When the pod travels across to a new zone, the server updates the zone associated with the pod to the new zone. A certain overlap of neighboring zones is allowed for a smooth transition. Therefore, each of the pods can be traced and located in real-time by a sensing and control system.

Data collected from mechanical, optical, or acoustic sensors in the guideway can be used by the server to detect and identify pods. Optionally, each pod may be equipped with a global positioning system (GPS) as a redundancy. The redundant information will assure the stability and robustness of the system. With G4 and G5 data communication, the routing and dispatching commands can be transferred to the autonomous vehicles in real-time. The distance between pods on the same guideway can be sensed by a laser distance sensor. When the distance is below an acceptable safety threshold, the server can trigger the brakes of the pods to avoid a collision.

Due to the intermittent nature of solar energy and the constant use of energy for transportation, a robust energy storage with sufficient capacity to balance energy harvesting and utilization is used with the solar PRT system. Returning to FIG. 8, in an exemplary embodiment, solar energy is collected from the roof 802 of the PRT system. The collected energy flows to a storage system, is released to batteries or fuel cells based on the energy demand, and is eventually used by the pods. Depending on the design of the energy storage and operation system, the batteries or, fuel cells can be merged either into the storage system or the pods. The pods can be charged at a PRT station using any recharge technology, including but not limited to wireless recharge technologies.

Both batteries and fuel cells can be used in a pod to power a motor that drives the pod. As the energy needed to drive a lightweight pod is relatively low, one can exchange or charge the batteries at the PRT stations. In an exemplary embodiment, many of the PRT stations are configured for charging the batteries or changing the batteries in a pod in emergency situations.

For example, the average electric vehicle (EV) has an energy consumption of 0.346 kWh/mile. An embodiment of the pod with full capacity has a maximum weight that is ⅓ of the weight of the EV. The pod also runs with less friction on the enclosed guideway rails. Due to the acceleration and deceleration facilitated by the latitude of the guideway (described above), the energy consumption by the overall guideway system will be further minimized.

For the large-scale application of the solar PRT system, a dedicated energy storage system or access to the grid may be used when energy is harvested from the roof 802 of the solar PRT structure, during the day, the roof 802 may generate more energy than the guideway system needs, but at night, the guideway system relies on the electric supply from the storage system. Using the grid, the solar PRT system performs similarly to a combination of a utility PV generator and an electricity customer. The grid would handle the energy balance issue, which could result in a huge impact on the existing grid.

In another embodiment, the smart cushion 1005 may be used as part of a smart mounting fixture for the longevity and stiffness of building integrated photovoltaic (BIPV) modules. BIPVs are photovoltaic modules that are incorporated into the building envelope and parts of the building components such as facades, windows, and roofs, by replacing conventional building materials. BIPV modules are supported by building frames and subjected to various environmental, dead, and live loads. Stress and deformation will be induced by those loads, which may lead to cell cracking, panel delamination, permanent deformation, or panel failure. The current service life of a BIPV module is approximately 20-30 years, mainly due to the failure of the module under the thermal cycle combined with different loads. BIPV modules are made of multi-layers of glass, PV cells, backsheet, or substrate packaged with a softcore of an encapsulant such as ethylene-vinyl acetate (EVA), polyvinyl butyral (PVB), thermoplastic silicone/polydimethylsiloxane (PDMS) elastomer, thermoplastic polyolefin (TPC) elastomer, and Ionomers. Although the cells are protected by the softcore for in-plane deformation, when they are bent, they are prone to crack. Moreover, the significant mismatch of material properties between layers, such as thermal expansion coefficient, stiffness, and strength, makes the modules susceptible to premature failure due to stress concentration caused by thermomechanical loads.

When a BIPV module is fixed on a frame with high flexural rigidity thereby less deformation, the stress concentration inside the module and leakage between the modules can be alleviated or avoided, significantly extending the service life with reduced life cycle costs of BIPV systems. Predictions of the stress and deflection of BIPV modules with the smart mounting structure are made in the structural design phase, including when the smart mounting structure is to be used with very large modules. Compared with the conventional building applied photovoltaic (BAPV) system, which is attached to and supported by the existing roof, the BIPV system is a part of the building structure and will transfer the load to the building framework and the foundation. The deflection and load capacity of BIPV modules will directly impact the functionality, appearance, and safety of the building. However, there is currently no specific building code for applying PV modules to the BIPV system. Engineers typically use existing building codes for general building materials with BIPV modules. In order to meet the building code requirement, extra-large solar modules with very thick glass sheets are used to reduce the deflection. This leads to high manufacturing costs and increases the dead load on the roof as well, which further increases the construction costs.

Contrary to the conventional BAPV system, a BIPV module of the invention is designed with a smart mounting fixture that includes a central, column, end clamps, and a smart cushion. The smart mounting fixture is designed to be a rigid support fixture for the BIPV module, such that the size of the module does not change with the load. In a preferred embodiment, the smart mounting fixture supports a large BIPV module. By adjusting the tension applied by the motor, the smart mounting fixture keeps the dimensions of BIPV modules unchanged under temperature and mechanical loading, thus minimizing the stress concentration due to the material difference in the layered structure. The lifetime of the brittle solar cells will be significantly extended with less micro-cracks and deformation. The spacing between the BIPV modules will not change with the environmental loads so that the silicone connection between BIPV modules will last longer and prevents water leakage, from the roof. In addition, the fixture increases the stiffness of the BIPV module by adding tension to the BIPV module. As a result, the deflection of the BIPV module can be reduced, and thinner, lighter modules are allowed for architectural and economic benefits. The smart mounting fixture of the invention can be installed in the field as part of the construction process or during the manufacturing of BIPV modules, Compared with the BIPV modules with no horizontal constraint or forces, the smart mounting fixture reduces the deflection of the BIPV modules under external loadings.

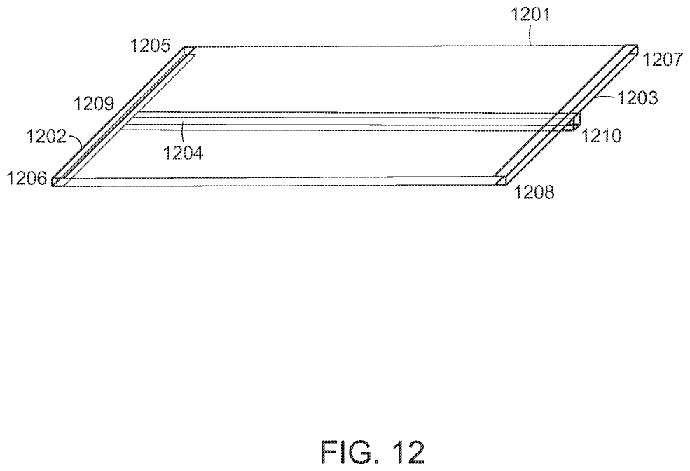

FIG. 12 illustrates a BIPV module with clamps and a center column. The BIPV module 1201 is composed of laminated glass sheets. Two end clamps 1202-1203 are installed at opposite ends of the BIPV module 1201. The length of the first clamp 1202 is coupled to a first end of the glass. The first clamp 1202 includes a first end 1205, a second and opposite end 1206, and a mid-point 1209 between the first and second ends 1205-1206. The length of the second clamp 1203 is coupled to a second end of the glass. The second clamp 1202 includes a first end 1207, a second and opposite end 1208, and a mid-point 1210 between the first and second ends 1207-1208. The clamps 1202-1203 may be composed of frictional pressure clamps with strong glue or rubber contact cushions. For a more rigid connection, prefabricated holes (not shown) in the glass of the BIPV module 1201 may be coupled to the clamps 1202-1203 using bolts. The number and size of the holes are designed to avoid damage to the glass when a load is applied to the holes. Although open-ended rectangular clamps are shown in FIG. 12, other shapes may also be used, such as an L or T shape. A central column 1204 is installed underneath the BIPV module 1201 and connects with the mid-points 1209-1210 of the two clamps 1202-1203. The column 1204 provides vertical support when the BIPV module 1201 exhibits large deflection, particularly at the center of the large BIPV module 1201. The column 1204 is not required to contact the BIPV module 1201 along its entire length.

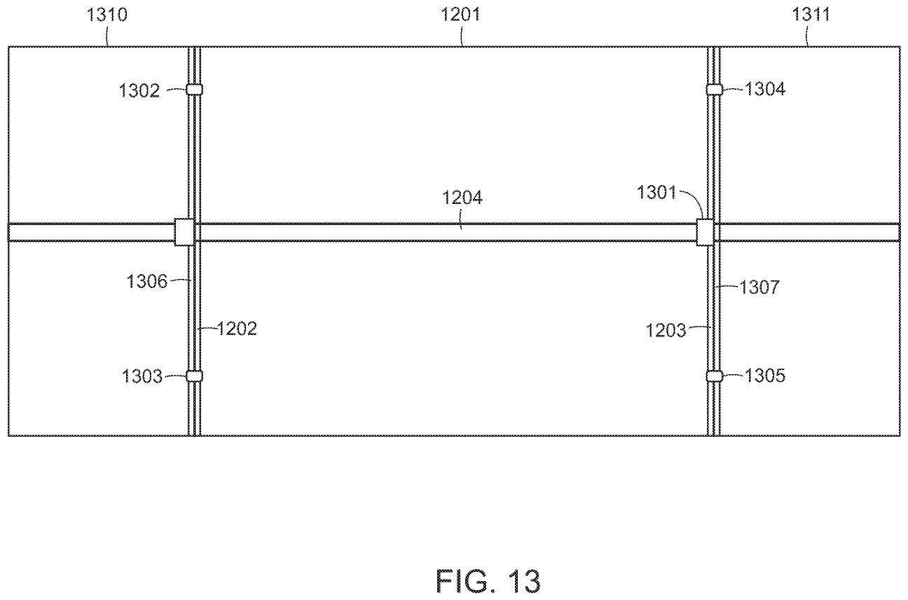

FIG. 13 illustrates the BIPV module 1201 with a smart cushion coupled to the clamps 1202-1203. The BIPV module 1201 is coupled to adjacent BIPV modules 1310-1311 via connectors 1302-1305. Optionally, a gap sensor (not shown) may be installed with the connectors 1302-1305 for diagnosis and monitoring purposes. Connected to one end of the BIPV module 1310 is a clamp 1306. The clamp 1306 of the BIPV module 1310 is next to the first clamp 1202 of the BIPV module 1201. Connected to one end of the BIPV module 1311 is a clamp 1307. The clamp 1307 of the BIPV module 1311 is next to the second clamp 1203 of the BIPV module 1201. The smart cushion 1301 has the same or similar structure as the smart cushion 1005, described above. When used with the BIPV module 1201, the first horizontal hinge point A is fixed on the second clamp 1203 of BIPV module 1201, and the second horizontal hinge point B is fixed on the first clamp 1307 of BIPV module 1311. The smart cushion 1301 pushes the central column 1204 and the second clamp 1203, in the manner described above, so as to apply tension to the BIPV module 1201 and to keep a constant spacing distance between the clamps of the BIPV module 1201 and the adjacent modules 1310-1311 to avoid leakage.

Given a climate zone, the highest temperature (Tₘₐₓ) in the area is estimated, and the natural length (L₀) of the module 1201 at this temperature is calculated. For purposes of illustration, a module 1201 with a size of 1 m (width)×2 m (length)=2 m² (area) is used, or L₀=2 m at Tₘₐₓ. The size of the module 1201 size is adjusted to L₀=2 m by the smart cushion 1301, and BIPV modules 1201 are installed on a roof structure with a fixed gap go (in the range of 3-6 mm), which is generally filled with transparent silicone (PDMS).

If the modules were mounted with conventional fixtures, the gap between modules will change with the weather and mechanical load. When PDMS is aged with degradation, a gap may become a crack during the thermal cycling load, which will lead to roof leakage. However, with the BIPV module 1201 of the invention, the smart cushion 1301 strengthens the module 1201 and keeps the length of the module 1201, and the gap with adjacent modules 1310-1311, constant. The smart cushion 1301 has the same or similar structure as the smart cushion 1005, described above. Referring to FIGS. 11A, 11B, and 13, the smart cushion 1301 resides at the interface between BIPV modules 1201 and 1311 and is proximate to the central column 1204. The horizontal hinge points A and B of the smart cushion 1301 are fixedly coupled to the clamps 1203 and 1307 with a distance a₀ in a range of 20-40 mm during the installation.

At the initial condition, the highest working temperature Tₘₐₓ for the region is determined. For example, Tₘₐₓ=90° C. for New York state on the roof. The length of the module at Tₘₐₓ=90° C. is calculated as L₀. If the temperature is different from Tₘₐₓ on the day of installation of the modules 1201, 1310-1311 on a roof, the smart cushion 1301 is used to adjust the width to L₀. This means that, when the temperature reaches Tₘₐₓ the smart cushion 1301 exhibits zero force.

During the installation, modular construction is used. The module 1201 with the clamp 1203 and smart cushion 1201 at width L₀ is installed onto the roof with enough horizontal support to stabilize the module 1201. The connectors 1302-1305 are used to connect the modules 1201, 1310, 1311. Optionally, a gap sensor is installed with the connectors 1302-1305 for diagnosis and monitoring purposes.

When the module 1201 experiences contraction due to a temperature decrease, the distance between the clamp 1203 and the clamp 1307 increases from their initial distance. As a result, the distance between the horizontal hinge points A-B increases from their initial distance, and the vertical hinge points C-D move toward each other. When the vertical hinge points C-D touch the inside electrodes 1131, the electrodes 1131 complete a first circuit 1101 and triggers the motor 1110. A current flows from the inside electrodes 1131 to the motor 1110, causing the motor 1110 to move the clamp 1203 away from the central column 1204, increasing the force on the central column 1204, and increasing the distance between the clamp 1203 and the clamp 1202. This causes the clamp 1203 to move closer to the clamp 1307 so that the distance between the horizontal hinge points A-B decreases. When the horizontal hinge points A-B recover their initial distance, the vertical hinge points C-D disengage from the electrodes 1131, turning off the motor 1110.

When the module 1201 experiences expansion due to a temperature increase, the distance between the clamp 1203 and the clamp 1307 decreases from their initial distance. As a result, the distance between the hinge points A-B decreases from their initial distance, and the vertical hinge points C-D move away from each other. When the vertical hinge points C-D touch the outside electrodes 1132, the electrodes 1132 complete a second circuit 1102 and triggers the motor 1110. An electric current flows from the motor 1110 to the outside electrodes 1132, causing the motor 1110 to move the clamp 1203 closer to the central column 1204, decreasing the force on the central column 1204, and decreasing the distance between the clamp 1203 and the clamp 1202. This causes the clamp 1203 to move away from the clamp 1307 so that the distance between the horizontal hinge points A-B increases. When the horizontal hinge points A-B recover their initial distance, the vertical hinge points C-D disengage from the electrodes 1132, turning off the motor 1110.

In some embodiments, the initial distance between the hinge points is set up at the highest working temperature. At this temperature, the smart cushion 1301 does not experience any force. At lower temperatures, there is pre-tension in the module 1201 and compression in the central column 1204 to maintain the initial distance, such that there is no pulling force from the smart cushion 1301 and the gap between the modules, 1201-1310 or 1201 and 1311 will stay constant.

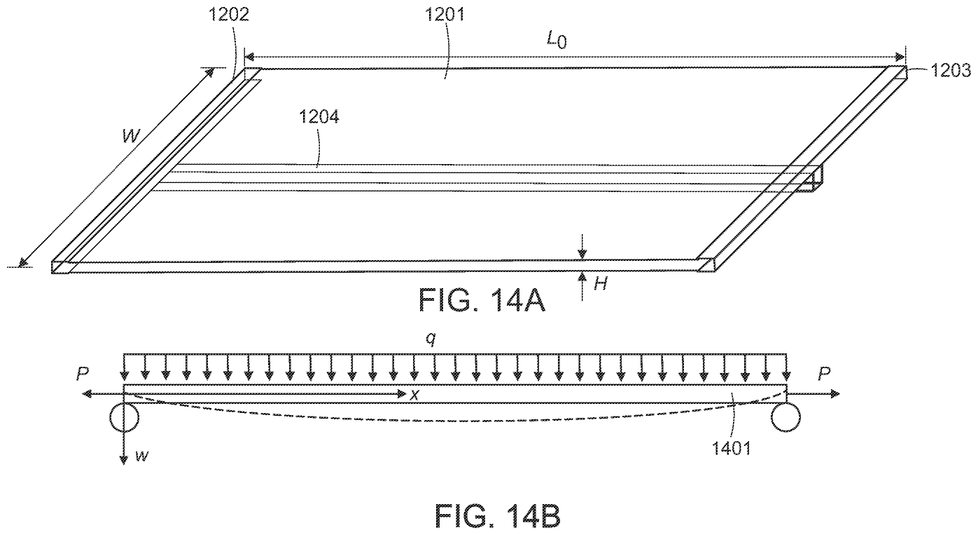

FIGS. 14A and 14B illustrate the stress analysis and deflection for the BIPV module 1201. FIG. 14A illustrates the geometry of the BIPV module 1201 with pre-tension force P at the end under a uniformly distributed load q on the top surface. FIG. 14B illustrates a simplified model of the BIPV module 1201 as a beam with two simply supported edges. The structural performance criteria include both the stress analysis to avoid the strength failure at the extreme loading scenario and also the maximal deformation of the structure which may produce visual impact and affect the serviceability of the roof Due to the relatively large span of solar panels, the maximal deflection often becomes the control factor. The traditional design based on the classic (Bernoulli Euler's) beam theory will not be able to accurately predict the deflection because the horizontal force is not considered. A new formulation is derived for the deflection of the BIPV module 1201 under a uniform tensional load q. FIG. 14B shows the geometry of the module with the thickness H, length L₀, and width W. Without considering the support of the central column 1204, which can provide additional support under a large deflection, the module 1201 with the two clamps 1202-1203 will exhibit cylindrical deformation, which can be simplified as a beam 1401, as illustrated in FIG. 14B. The coordinate x is set up along the neutral axis (NA) of the beam. The deflection of the NA is denoted by w(x). The smart cushion 1301 provides a pre-tension force P at the end of the module 1201.

The deflection for a simply supported module can be written as:

$$w = \frac{q {L}_{0}^{4}}{16 {u}^{4} \overline{EI}} [ \frac{cosh u ( 1 - \frac{2 x}{{L}_{0}} )}{cosh u} - 1 ] + \frac{q {L}_{0}^{2} x ( {L}_{0} - x )}{8 {u}^{2} \overline{EI}}$$

where El is the effective flexural rigidity of the panel at a unit length, L₀ is the span of the module, x is the distance from one end toward the other end; and

$$u = \sqrt{\frac{P}{\overline{EI}}} \frac{{L}_{0}}{2} .$$

The maximum deflection is at the mid-point and is calculated as:

$${w}_{max} = \frac{q {L}_{0}^{4}}{16 {u}^{4} \overline{EI}} [ \frac{1}{cosh u} - 1 ] + \frac{q {L}_{0}^{4}}{32 {u}^{2} \overline{EI}} .$$

The above deflection can be much smaller than the solution provided by the classic beam theory as

$$w = \frac{q x}{24 \overline{EI}} ( {x}^{3} - 2 {L}_{0} {x}^{2} + {L}_{0}^{3} )$$

particularly when P is comparable to qL₀. The maximum deflection at the mid span calculated using classic beam theory is

$${w}_{max} = \frac{5 q {L}_{0}^{4}}{384 \overline{EI}} .$$

In parallel, the deflection for a clamped module can be written as

$$w = \frac{{qL}_{0}^{4}}{16 {u}^{3} \overline{EI}} [ \frac{cosh u ( 1 - \frac{2 x}{{L}_{0}} ) - cosh u}{sinh u} ] + \frac{q {L}_{0}^{2} x ( {L}_{0} - x )}{8 {u}^{2} \overline{EI}}$$

The maximal deflection is at the mid-point as

$${w}_{max} = \frac{q {L}_{0}^{4}}{16 {u}^{3} \overline{EI}} [ \frac{1 - cosh u}{sinh u} ] + \frac{q {L}_{0}^{4}}{32 {u}^{2} \overline{EI}} .$$

The classic beam theory for the clamped module is

$$w = \frac{{qx}^{2}}{24 EI} {( {L}_{0} - x )}^{2}$$

with the maximum deflection at the mid-point equal to

$${w}_{max} = \frac{{qL}_{0}^{4}}{384 EI} .$$

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

All components of the device and their locations, electronic communication methods between the system components, magnet types, cables, wiring, attachment or securement mechanisms, mechanical connections, electrical connections, dimensions, values, materials, charging methods, battery types, applications/uses, tools and devices that can be used therewith, etc. discussed above or shown in the drawing, if any, are merely by way of example and are not considered limiting and other component(s) and their locations, electronic communication methods, magnet types, cables, wiring, attachment or securement mechanisms, mechanical connections, electrical connections, dimensions, values, materials, charging methods, battery types, applications/uses, tools and devices that can be used therewith, etc. can be chosen and used and all are considered within the scope of the disclosure.

The flowchart, and block diagrams in the Figures illustrate the architecture, functionality, and operation of possible implementations of systems, methods, and computer program products according to various embodiments of the present invention. In this regard, each block in the flowchart or block diagrams may represent a module, segment or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill, in the art without departing from the spirit and scope of the appended claims.

What is claimed is:

1. A transit system, comprising:
a rail guideway comprising one or more junctures, each juncture comprising:
main tracks comprising a first main rail and a second main rail;
turn tracks comprising a first turn rail and a second turn rail;
a first tongue rail comprising a first end aligned with: the first main rail and a moveable second end; and
a second tongue rail comprising a first end aligned with the second turn rail and a moveable second end;
a drive unit comprising:
a first set of wheels for traveling on the first main rail, each of the first set of wheels comprising a first flange residing proximate to an outside edge of the first main rail and distal from an inside edge of the first main rail; and
a second set of wheels for traveling on the second main rail, each of the second set of wheels comprising a second flange residing proximate to an outside edge of the second main rail and distal from an inside edge of the second main rail; and
a switch control system, comprising:
a switch blade comprising a pivot end and a movable end, the pivot end residing at a location proximate to the second main rail and the first turn rail, wherein a gap exists between the pivot end, the second main rail, and the first turn rail,
wherein to facilitate a movement of the drive unit from the main tracks to the turn tracks:
the moveable end of the first tongue rail is positioned to form a gap between the movable end of the first tongue rail and the first main rail,
the movable end of the switch blade is positioned to align with the first main rail, and
the moveable end of the second tongue rail is positioned to align with the second main rail.

2. The system of claim 1, wherein, to facilitate a movement of the drive unit to continue on the main tracks:
the moveable end of the first tongue rail is positioned to align with the first main rail;
the moveable end of the switch blade is positioned to align with the second main rail; and
the movable end of the second tongue rail is positioned to form a gap between the moveable end of the second tongue rail and the second main rail.

3. The system of claim 1, wherein the rail guideway comprises an enclosure, wherein the main tracks, the turn tracks, the first tongue rail, and the second tongue rail reside within the enclosure, wherein the drive unit travels within the enclosure.

4. The system of claim 3, wherein the drive unit, comprises an autonomous vehicle configured to carry persons or objects, wherein the autonomous vehicle is coupled to the drive unit using a hanger, wherein the autonomous vehicle is positioned below the rail guideway.

5. The system of claim 4, wherein the rail guideway further comprises an opening at a bottom of the enclosure and along a length of the enclosure, wherein as the drive unit travels within the enclosure, the hanger travels through the opening.

6. The system of claim 1, wherein the turn tracks are positioned at a higher latitude than the main tracks.

7. The system of claim 1, wherein the rail guideway further comprises one or more circular tracks for facilitating U-turns for the drive unit.

8. The system of claim 1, further comprising one or more solar personal rapid transit structures comprising a roof, the roof comprising one or more solar panels for generating power for the transit system.

9. The system of claim 1, wherein the rail guideway further comprising one or more pre-tension frames, each pre-tension frame comprising:
a central beam coupled to a section of the rail guideway;
a first girder coupled to a first end of the frame and to the central beam;
a second girder coupled to a second end of the frame;
a smart cushion coupled between the central beam and the second girder,
wherein the smart cushion adjusts the length of a section of the guideway based on changes in environmental temperature.

10. The system of claim 9, wherein the smart cushion comprises:
a first horizontal hinge point coupled to the second girder of the frame and a second horizontal hinge point coupled to a first girder of an adjacent frame, the first horizontal hinge point positioned at an initial distance from the second horizontal hinge point;
a first vertical hinge point and a second vertical hinge point coupled to the first horizontal hinge point and the second horizontal hinge point at approximately equal angles;
a first pair of electrodes positioned on an inside distance between the first vertical hinge point and the second vertical hinge point;
a second pair of electrodes positioned on an outside distance between the first vertical hinge point and the second vertical hinge point;
a plurality of links, comprising:
a first link coupled to the first horizontal hinge point and the first vertical hinge point;
a second link coupled to the first vertical hinge point and the second horizontal hinge point;
a third link coupled to the second horizontal hinge point and the second vertical hinge point; and
a fourth link coupled to the second vertical hinge point and the first horizontal hinge point:
a motor coupled to the first pair of electrodes and the second pair of electrodes,
wherein, when the first pair of electrodes touch the first and second vertical hinge points, a first current flows from the first pair of electrodes to the motor, wherein a compressive force on the central beam is increased, a distance between the first and second girders of the frame is increased, a distance between the second girder of the frame and the first girder of the adjacent frame is decreased, and a distance between the first and second horizontal hinge points is decreased,
wherein, when the second pair of electrodes touch the first and second vertical hinge points, a second current flows from the motor to the second pair of electrodes, wherein the compressive force on the central beam is decreased, the distance between the first and second girders of the frame is decreased, the distance between the second girder of the frame and the first girder of the adjacent frame is increased, and the distance between the first and second horizontal hinge points is increased.

11. The system of claim 10, wherein when the first and second horizontal hinge points recover the initial distance between the first and second horizontal hinge points, the first or second pair of electrodes disengage from the first and second vertical hinge points and turn off the motor.

12. A building integrated photovoltaic (BIPV) module, comprising:
laminated glass comprising a first end and a second end;
a first clamp comprising a first end, a second end, and a first mid-point of the first clamp, wherein a length, of the first clamp is coupled to a first end of the BIPV module;
a second clamp comprising a first end, a second end, and a second mid-point of the second clamp, wherein a length of the second clamp is coupled to a second end of the BIPV module;
a central column comprising a first end and a second end of the central column, the first end of the central column coupled to the first mid-point of the first clamp, the second end of the central column coupled to the second mid-point of the second clamp, wherein the central column is coupled beneath the BIPV module; and
a smart cushion coupled between the central column and the second clamp, wherein the smart cushion adjusts a length of a section of the BIPV module based on changes in environmental temperature.

13. The module of claim 12, wherein the smart cushion comprises:
a first horizontal hinge point coupled to the second clamp of the section of the BIPV module and a second horizontal hinge point coupled to a first clamp of a second of an adjacent BIPV module, the first horizontal hinge, point positioned at an initial distance from the second horizontal hinge point;
a first vertical hinge point and a second vertical hinge point coupled to the first horizontal hinge point and the second horizontal hinge point at approximately equal angles;
a first pair of electrodes positioned on an inside distance between the first vertical hinge point and the second vertical hinge point;
a second pair of electrodes positioned on an outside distance between the first vertical hinge point and the second vertical hinge point;
a plurality of links, comprising:
a first link coupled to the first horizontal hinge point and the first vertical hinge point;
a second link coupled to the first vertical hinge point and the second horizontal hinge point;
a third link coupled to the second horizontal hinge point and the second vertical hinge point; and
a fourth link coupled to the second vertical hinge point and the first horizontal hinge point;
a motor coupled to the first pair of electrodes and the second pair of electrodes,
wherein, when the first pair of electrodes touch the first and second vertical hinge points, a first current flows from the first pair of electrodes to the motor, wherein a compressive force on the central column is increased, a distance between the first and second clamps of the BIPV module section is increased, a distance between the second girder of the BIPV module section and the first girder of the adjacent BIPV module section is decreased, and a distance between the first and second horizontal hinge points is decreased,
wherein, when the second pair of electrodes touch the first and second vertical hinge points, a second current flows from the motor to the second pair of electrodes, wherein the compressive force on the central column in decreased, the distance between the first and second clamps of the BIPV module section is decreased, the distance between the second girder of the BIPV module section and the first girder of the adjacent BIPV module section is increased, and the distance between the first and second horizontal hinge points is increased.

14. The module of claim 13, wherein when the first and second horizontal hinge points recover the initial distance between the first and second horizontal hinge points, the first or second pair of electrodes disengage from the first and second Vertical hinge points and turn off the motor.
